(19) United States
(12) Patent Application Publication
(10) Pub. No.: US 2025/0208635 A1
(43) Pub. Date: Jun. 26, 2025

(54) SYSTEM AND METHOD OF SMART LEAKAGE DETECTION

(71) Applicant: Ali DIANAT, North York (CA)

(72) Inventor: Ali DIANAT, North York (CA)

(21) Appl. No.: 18/990,583

(22) Filed: Dec. 20, 2024

Related U.S. Application Data
(60) Provisional application No. 63/614,190, filed on Dec. 22, 2023.

(51) Int. Cl. G05D 7/06; E03B 7/00; E03B 7/07; F17D 5/00; F17D 5/02

(52) U.S. Cl. CPC G05D 7/0635; E03B 7/003; E03B 7/071; F17D 5/005; F17D 5/02

(57) ABSTRACT

Systems and methods of detection are provided. One method comprises receiving a first signal at a transmitter electronically connected to a sensor, sending from the transmitter to a receiver a second signal, and actuating a valve actuator to shut a supply valve responsive. The first and second signals each represent a detected event. One system comprises an event detection subsystem and a valve subsystem. The event detection subsystem comprises a sensor, a transmitter, a first processor, and a first memory storing instructions which when executed by the first processor configure the first processor to perform method steps. The valve subsystem comprises a valve actuator physically connected to a supply valve, a receiver, a second processor, and a second memory storing instructions which when executed by the second processor configure the second processor to perform method steps.

### CROSS REFERENCE TO RELATED APPLICATIONS

This application claims the benefit of and priority to U.S. provisional application No. 63/614,190 filed Dec. 22, 2023, the contents of which are hereby incorporated by reference.

### FIELD

The present disclosure generally relates to gas and water supply, and in particular to a system and method of smart leakage or event detection.

### INTRODUCTION

Water or gas leakage from pipes can cause damage to a home or premises.

### SUMMARY

In accordance with an aspect, there is provided a detection system. The system comprises an event detection subsystem and a valve subsystem. The event detection subsystem comprises a sensor for detecting an event, a transmitter, a first processor electrically connected to the sensor and to the transmitter, and a first memory storing instructions which when executed by the first processor configure the first processor to receive a first signal from the sensor, and to configure the transmitter to send a second signal to the valve subsystem. The valve subsystem comprises a valve actuator physically connected to a supply valve, a receiver, a second processor electrically connected to the valve actuator and to the receiver, and a second memory storing instructions which when executed by the second processor configure the second processor to receive the second signal from the transmitter, and to actuate the valve actuator to shut the supply valve. The first and second signals each representing that an event has been detected.

In accordance with another aspect, there is provided a method of detection. The method comprises receiving from a sensor a first signal at a transmitter electronically connected to the sensor, sending from the transmitter to a receiver a second signal, and actuating a valve actuator to shut a supply valve responsive to the receiving of the second signal. The first and second signals each representing that an event has been detected.

In accordance with another aspect, there is provided a system for leakage detection. The system comprises a moisture detection subsystem and a water valve subsystem. The moisture detection subsystem comprises a moisture sensor for detecting moisture, a transmitter, a first processor electrically connected to the moisture sensor and to the transmitter, and a first memory storing instructions which when executed by the first processor configure the first processor to receive a first signal from the moisture sensor, and to configure the transmitter to send a second signal to the water valve subsystem. The water valve subsystem comprises a valve actuator physically connected to a water supply valve, a receiver, a second processor electrically connected to the valve actuator and to the receiver, and a second memory storing instructions which when executed by the second processor configure the second processor to receive the second signal from the transmitter, and to actuate the valve actuator to shut the water supply valve. The first and second signals each representing that moisture above a level has been detected.

In accordance with another aspect, there is provided a method of leakage detection. The method comprises receiving from a moisture sensor a first signal at a transmitter electronically connected to the moisture sensor, sending from the transmitter to a receiver a second signal, and actuating a valve actuator to shut a water supply valve responsive to the receiving of the second signal. The first and second signals each representing that moisture above a level has been detected.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a component diagram, an example of a detection system, in accordance with some embodiments;

FIG. 2 illustrates, in a flowchart, an example of a method of event detection, in accordance with some embodiments;

FIG. 3 illustrates, in a schematic diagram, an example of a water detection subsystem, in accordance with some embodiments;

FIG. 4 illustrates, in a schematic diagram, an example of a water actuating subsystem, in accordance with some embodiments

FIG. 5 illustrates, in a flowchart, an example of a method of water leakage detection, in accordance with some embodiments;

FIG. 6 is a schematic diagram of a processing module; and

FIG. 7 is a schematic diagram of a computing device such as a server or other computer.

It is understood that throughout the description and figures, like features are identified by like reference numerals.

### DETAILED DESCRIPTION

Embodiments of methods, systems, and apparatus are described through reference to the drawings. Applicant notes that the described embodiments and examples are illustrative and non-limiting. Practical implementation of the features may incorporate a combination of some or all of the aspects, and features described herein should not be taken as indications of future or existing product plans.

In some embodiments, there is provided an automated detection system. The automated detection system may comprise a water leakage detection system, a gas leakage detection system, and/or a vibration/movement/earthquake detection system.

In some embodiments, an event detection system is provided. The system comprises an event detection subsystem and a valve subsystem. The event detection subsystem comprises a sensor for detecting an event, a transmitter, a first processor electrically connected to the sensor and to the transmitter, and a first memory storing instructions which when executed by the first processor configure the first processor to receive a first signal from the sensor, and to configure the transmitter to send a second signal to the valve subsystem. The valve subsystem comprises a valve actuator physically connected to a supply valve, a receiver, a second processor electrically connected to the valve actuator and to the receiver, and a second memory storing instructions which when executed by the second processor configure the second processor to receive the second signal from the transmitter, and to actuate the valve actuator to shut the supply valve. The first and second signals each representing that an event has been detected.

In some embodiments, the sensor comprises one of a moisture sensor, a gas sensor or an earthquake sensor.

In some embodiments, the event comprises one of moisture above a certain level representing a water leak, gas detected above a certain level representing a gas leak, or vibration or other movement detected above a certain level representing an earthquake.

In some embodiments, the valve subsystem comprises a water valve subsystem and the supply valve comprises a water supply valve.

In some embodiments, the valve subsystem comprises a gas valve subsystem and the supply valve comprises a gas supply valve.

In some embodiments, the valve subsystem includes a mobile application configured to receive the second signal and initiate a warning message. In some embodiments, the mobile application is further configured to receive an input in response to the warning message and send a signal to actuate the valve actuator.

In some embodiments, the detection system comprises an automated smart leakage detection system. The automated smart leakage detection system may comprise a water leakage detection system, a gas leakage detection system, and/or a vibration detection system.

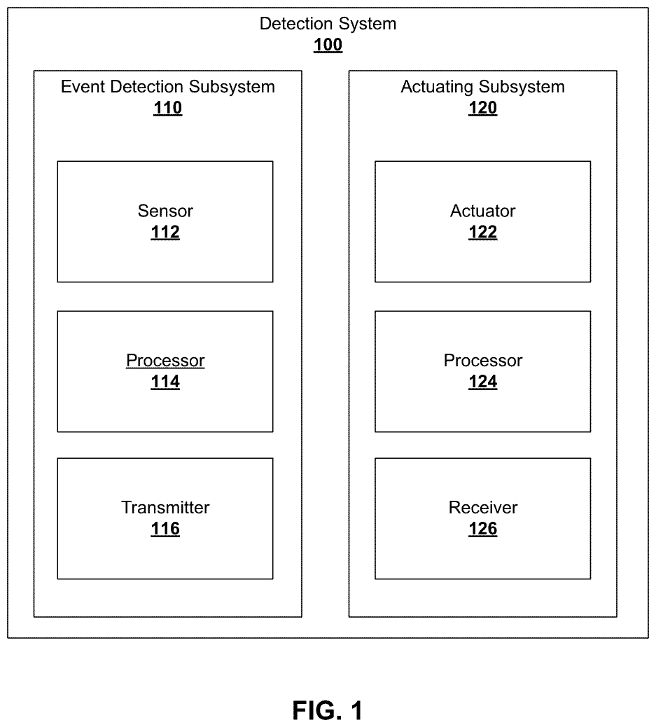

FIG. 1 illustrates, in a component diagram, an example of a detection system 100, in accordance with some embodiments. The detection system comprises a detection subsystem 110, and an actuating subsystem 120. Other components may be added to the system 100.

The detection subsystem 110 comprises at least one sensor 112, at least one processor (e.g., a first processor) 114, and at least one transmitter 116. In some embodiments, the at least one sensor 112 may comprise one or more moisture sensors, one or more gas sensors, and/or one or more vibration sensors. The first processor 114 may be configured to receive a first signal from the at least one sensor 112 indicating that the at least one sensor 112 has detected a measurement above a threshold level. For example, a moisture sensor has detected moisture above a threshold level set for that moisture sensor. The first signal may be sent via a wired electrical connection between the sensor and the transmitter. The at least one sensor 112 may be positioned anywhere leakage may be found. For example, a moisture sensor may be placed along water piping throughout a building (e.g., home, office, factories, refineries or any other building), a gas sensor may be placed along gas piping, and a vibration sensor may be placed near water or gas piping. In some embodiments, the vibration sensor detects an earthquake rather than a leakage.

In response to receiving the first signal, the processor 114 may be configured to transmit a second signal to a receiver in the actuating subsystem 120. The transmission may be via a wired connection or via a wireless connection. In some embodiments, the second signal may be a retransmission of the first signal. Other components may be added to the detection subsystem 110.

The actuating subsystem 120 comprises at least one receiver 122, at least one processor (e.g., a second processor) 124, and at least one valve actuator 126. The at least one valve actuator 126 may be attachably connected to a valve (not shown) such that when actuated, the valve actuator 126 physically causes the valve to shut off. The second processor 124 may be configured to receive the second signal from the at least one receiver 122 and actuate the at lest one valve actuator 126. Other components may be added to the actuating subsystem 120.

It should be understood that the valve could be one or more water valves, one or more gas valves, or a combination of one or more water and one or more gas valves. In some embodiments both water and gas valves shut off in in response to any type of sensor detecting an event (e.g., water leakage, gas leakage, earthquake, etc.). In some embodiments, the water and/or gas valves are shut if both an earthquake and a corresponding water/moisture or gas leakage is detected. In some embodiments, the water and/or gas valves are shut if only an earthquake is detected. It should be understood that other valves may be configured to shut if an event is detected by a sensor.

It should be understood that an event may comprise moisture above a certain level representing a water leak, gas detected above a certain level representing a gas leak, and/or movement detected above a certain level representing an earthquake.

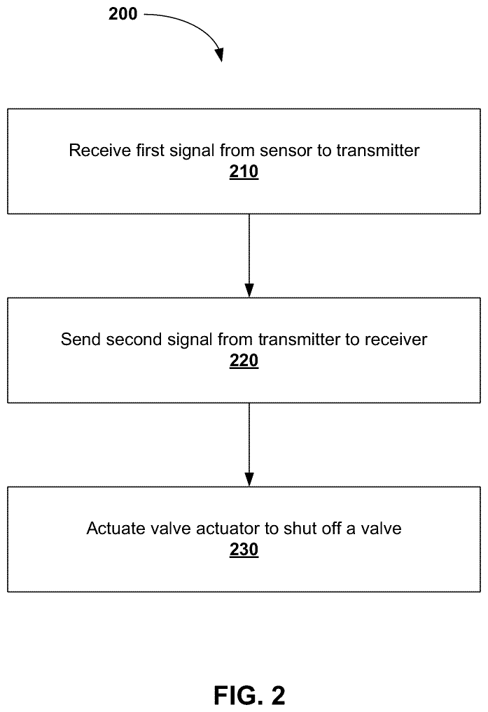

FIG. 2 illustrates, in a flowchart, an example of a method of event detection 200, in accordance with some embodiments. The method 200 comprises receiving 210 from a sensor 112 a first signal at a transmitter 116 electronically connected to the sensor 112, sending 220 from the transmitter 116 to the receiver 126 a second signal, and actuating 230 a valve actuator 122 to shut the valve responsive to the receiving of the second signal. The first and second signals each represent that the sensor has detected an event (e.g., a measurement above a threshold level). Other steps may be added to the method 200.

In some embodiments, the valve actuator is a one-way actuator that only rotates a valve in the direction to shut it off. In order to rotate the valve to turn it back on, it is manually rotated, and the actuating subsystem manually reset. This is a safety measure to prevent the valve from being turned on remotely without human inspection. In some examples, the one-way actuator may comprise a diode switch.

In some embodiments, the valve is a water valve. The water valve may be a main water valve to a building that can be shut off to prevent water damage and/or flooding due to a leak.

In some embodiments, the valve is a gas valve (e.g., liquified natural gas (LNG), liquified petroleum gas (LPG)). The gas valve may be a main gas valve to a building that can be shut off to prevent gas from spreading in the building.

In some embodiments, the sensor is a vibration sensor (e.g., an earthquake sensor) to a foundation, water pipe(s) or gas pipe(s) of a building. When the vibration sensor senses that vibration is above a safe level, then a water valve (e.g., main water valve) and/or a gas valve (e.g., main gas valve) to a building may be shut off.

In some embodiments the transmitter sends the signal wirelessly (e.g., using wifi) to the receiver. In some embodiments, the transmitter may be wired to the receiver when the sensor is close to the actuating subsystem. In some embodiments, the sensor 112 is directly electrically coupled to the processor in the actuating subsystem 120 without the need for a receiver, transmitter, or detection subsystem processor.

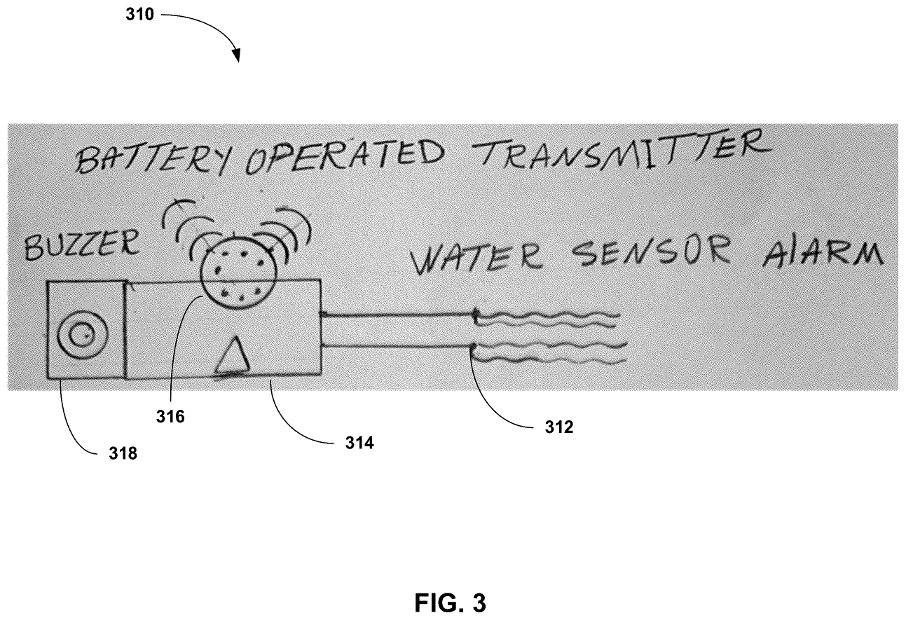

FIG. 3 illustrates, in a schematic diagram, an example of a water detection subsystem 310, in accordance with some embodiments. The detection subsystem 310 includes one or more water sensors 312, a unit that includes a processor 314 and a transmitter 316. In some embodiments, the transmitter 316 is a battery-operated transmitter. Optionally, a buzzer 318 may be included for audio indication of the location of the water detection subsystem 310. In embodiments where two or more water detection subsystems are implemented, the buzzers 318 may allow for quick audio detection of the location of the water detection subsystem that has detected the moisture or water leakage. In some embodiments, a light may be included for visual indication of the location of the water detection subsystem 310. Other components may be added to the water detection subsystem 310.

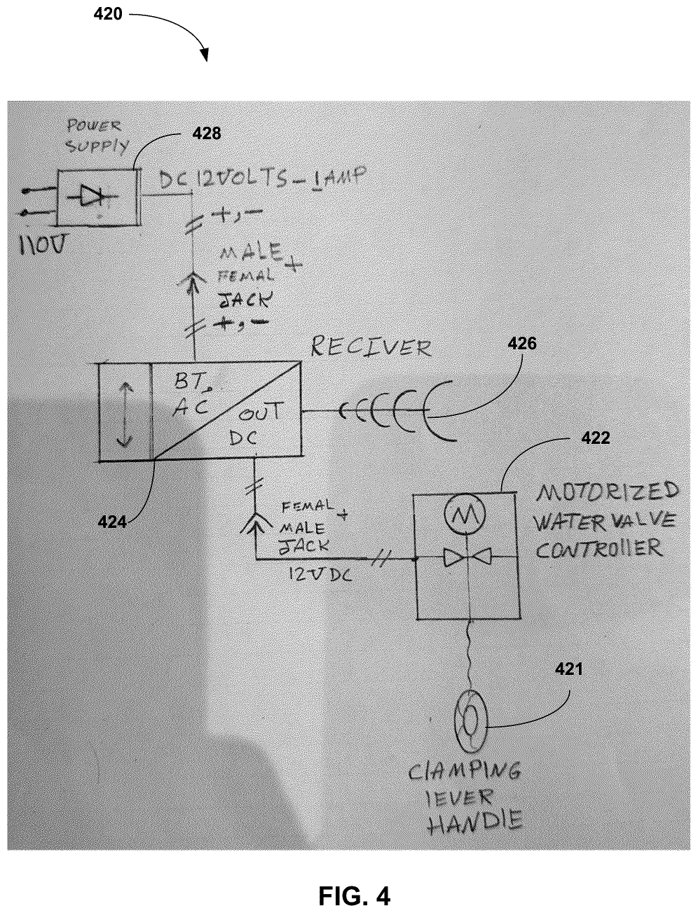

FIG. 4 illustrates, in a schematic diagram, an example of a water (or moisture) valve actuating subsystem 420, in accordance with some embodiments. The water valve actuating subsystem 420 comprises a power supply 428, a unit including a processor 424 and receiver 426, and a motorized water valve controller 422 coupled to a clamping lever handle 421 of a water valve (e.g., main water valve in a building). In some embodiments, the power supply 428 may be a battery, or include a back-up battery when electrical power of the building is out. In some embodiments, the unit is electrically coupled to the motorized water valve controller.

In some embodiments, the motorized water valve controller activates a one-way actuator that only rotates a water valve (e.g., main water valve for a building) in the direction to shut it off. In order to rotate the valve to turn it back on, it is manually rotated, and the actuating subsystem manually reset. This is a safety measure to prevent the valve from being turned on remotely without human inspection. In some examples, the motorized water valve controller may comprise a diode switch.

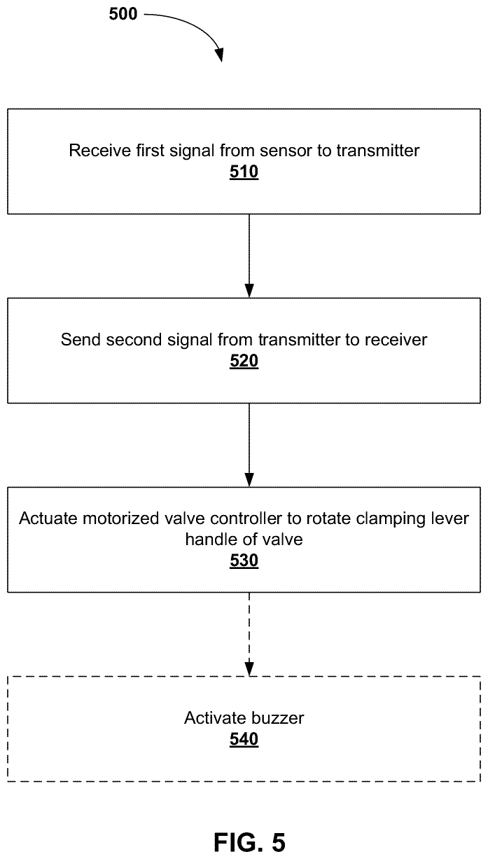

FIG. 5 illustrates, in a flowchart, an example of a method of water leakage detection 500, in accordance with some embodiments. The method 500 comprises receiving 510 from a water sensor 312 a first signal at a transmitter 316 electronically connected to the water sensor 312, sending 520 from the transmitter 316 to the receiver 426 a second signal, and responsive to the receiving of the second signal, actuating 530 a motorized valve controller 422 to rotate a clamping lever handle 421 of to shut the water valve. The first and second signals each represent that the sensor has detected a measurement above a threshold level. Optionally, the buzzer 428 may be activated to provide an audible indication of the approximate location of the water sensor 312. Other steps may be added to the method 500.

It should be understood that the system and method of water leakage detection may be converted to a system and method of gas leakage detection by replacing the water sensor 312 with a gas sensor, and having the motorized valve controller 422 rotate a clamping lever handle 421 to shut off a gas valve (e.g., main gas valve to a building).

It should be understood that the water sensor may be replaced with a vibration sensor. As such, when vibration of a building foundation, water pipe, or gas pipe is past a safe threshold, motorized valve controllers may be configured to rotate a main water valve and/or main gas valve to shut off the water and/or gas to the building.

In some embodiments, several water sensors (and/or gas and/or vibration sensors) may be placed throughout a building in any areas that could potentially have a leakage (e.g., under sinks, pipes, basement floors, basement walls, etc.). When the water sensors (and/or gas and/or vibration sensors) sense the present of excess moisture or water, the buzzer may actuate, and the transmitter signal the main receiver box through radio frequency (RF). Then, the actuating subsystem processor instructs the water valve actuator (and/or gas valve actuator) through wire, which is installed on the main water valve (and/or main gas valve), to shut off the valve. The receiver is connected to the electricity in general, but it can switch to use its battery in the event of a power outage. The water (and/or gas) valve actuating subsystem can only be turned back on manually, otherwise it will remain closed.

In some embodiments, each sensor may be coupled to its own detection unit. In other embodiments, two or more sensors may be coupled to a central detection subsystem where each sensor is serialized and monitored. In some embodiments, the sensors or detection units may be placed in parallel for individual detection. Is some embodiments the sensors or detection units may be placed in series for a complex or combined detection. In some embodiments, different combinations of sensors may be combined in a detection unit.

In some embodiments, the valve subsystem includes a mobile application configured to receive the second signal and initiate a warning message. In some embodiments, the mobile application is further configured to receive an input in response to the warning message and send a signal to actuate the valve actuator.

In some embodiments, the mobile application may be installed in a device that comprises the second memory and second processor 124. In some embodiments, the mobile application may be installed on a device that comprises a third memory and third processor. In some embodiments, the mobile application may comprise the buzzer 428.

In some embodiments, the system 100 may be configured to send a message to a mobile application rather than sending a signal to shut a valve. In some embodiments, the mobile application may then receive input and in response send the second signal to the actuating subsystem 120.

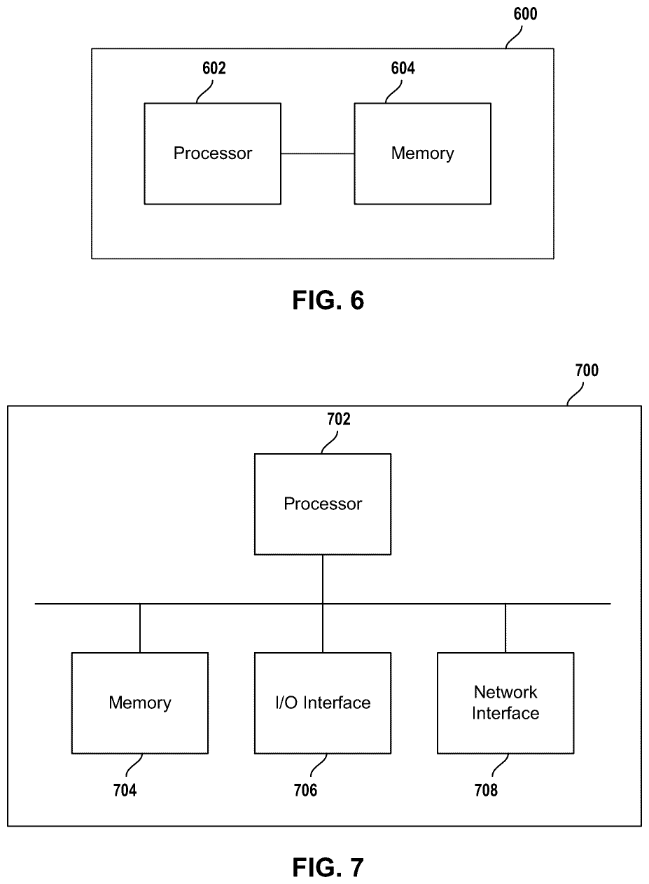

FIG. 6 is a schematic diagram of a processing module 600. As depicted, the processing module includes at least one processor 602, and memory 604. In some embodiments, processing module 600 may be implemented as part of the detection subsystem 110, 310 and the actuating subsystem 120, 420.

In some embodiments, the at least one processor 602 may be an Intel or AMD x86 or x64, PowerPC, ARM processor, or the like. Memory 604 may include a suitable combination of computer memory that is located either internally or externally such as, for example, random-access memory (RAM), read-only memory (ROM), compact disc read-only memory (CDROM).

FIG. 7 is a schematic diagram of a computing device 700 such as a server or other computer. As depicted, the computing device includes at least one processor 702, memory 704, at least one I/O interface 706, and at least one network interface 708.

Processor 702 may be an Intel or AMD x86 or x64, PowerPC, ARM processor, or the like. Memory 704 may include a suitable combination of computer memory that is located either internally or externally such as, for example, random-access memory (RAM), read-only memory (ROM), compact disc read-only memory (CDROM).

Each I/O interface 706 enables computing device 700 to interconnect with one or more input devices, such as a keyboard, mouse, camera, touch screen and a microphone, or with one or more output devices such as a display screen and a speaker.

Each network interface 708 enables computing device 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The foregoing discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, references made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

A portion of the technical solution of some embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by some embodiments.

Some embodiments described herein are implemented by physical computer hardware, including processing modules, computing devices, servers, receivers, transmitters, processors, memory, displays, and networks. The embodiments described herein provide useful physical machines and particularly configured computer hardware arrangements in combination with other physical components.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A detection system comprising:
an event detection subsystem comprising:
a sensor;
a transmitter;
a first processor electrically connected to the sensor and to the transmitter; and
a first memory storing instructions which when executed by the first processor configure the first processor to:
receive a first signal, from the sensor, representing that an event has been detected; and
configure the transmitter to send a second signal, to a valve subsystem, representing that the event has been detected; and
the valve subsystem comprising:
a valve actuator physically connected to a supply valve;
a receiver;
a second processor electrically connected to the valve actuator and to the receiver; and
a second memory storing instructions which when executed by the second processor configure the second processor to:
receive the second signal from the transmitter;
actuate the valve actuator to shut the supply valve.

2. The system as claimed in claim 1, wherein the sensor comprises one of a moisture sensor, a gas sensor or an earthquake sensor.

3. The system as claimed in claim 1, wherein the event comprises one of:
moisture above a certain level representing a water leak;
gas detected above a certain level representing a gas leak; or
movement detected above a certain level representing an earthquake.

4. The system as claimed in claim 1, wherein:
the valve subsystem comprises a water valve subsystem and the supply valve comprises a water supply valve; or
the valve subsystem comprises a gas valve subsystem and the supply valve comprises a gas supply valve.

5. The system as claimed in claim 1, wherein:
the valve subsystem includes a mobile application configured to:
receive the second signal; and
initiate a warning message.

6. The system as claimed in claim 5, wherein the mobile application is further configured to:
receive an input in response to the warning message; and
send a signal to actuate the valve actuator.

7. The system as claimed in claim 1, wherein the valve actuator is only configured to electronically shut down the supply valve and cannot electronically turn on the supply valve.

8. The system as claimed in claim 1, wherein a plurality of event sensors are configured in parallel to detect a plurality of events.

9. The system as claimed in claim 1, wherein a plurality of event sensors are configured in series to detect a combined event.

10. A detection method, the method comprising:
receiving from a sensor a first signal at a transmitter electronically connected to the sensor, the first signal representing that an event has been detected;
sending, from the transmitter to a receiver, a second signal representing that the event has been detected; and
responsive to the receiving of the second signal, actuating a valve actuator to shut a supply valve.

11. The method as claimed in claim 10, wherein the sensor comprises one of a moisture sensor, a gas sensor or an earthquake sensor.

12. The method as claimed in claim 10, wherein the event comprises one of:
moisture above a certain level representing a water leak;
gas detected above a certain level representing a gas leak; or
movement detected above a certain level representing an earthquake.

13. The method as claimed in claim 10, wherein:
the supply valve comprises a water supply valve; or
the supply valve comprises a gas supply valve.

14. The method as claimed in claim 10, comprising:
receiving, at a mobile application, the second signal; and
initiating, at the mobile application, a warning message.

15. The method as claimed in claim 14, comprising:
receiving, at the mobile application, an input in response to the warning message; and
sending, by the mobile application, a signal to actuate the valve actuator.

16. The method as claimed in claim 10, wherein the valve actuator is only configured to electronically shut down the supply valve and cannot electronically turn on the supply valve.

17. The method as claimed in claim 10, wherein a plurality of event sensors are configured in parallel to detect a plurality of events.

18. The method as claimed in claim 10, wherein a plurality of event sensors are configured in series to detect a combined event.
